(19) United States
(12) Patent Application Publication
(10) Pub. No.: US 2025/0054685 A1
(43) Pub. Date: Feb. 13, 2025

(54) COIL COMPONENT

(71) Applicant: SAMSUNG ELECTRO-MECHANICS CO., LTD., Suwon-si (KR)

(72) Inventors: Tae Hyun Kim, Suwon-si (KR); Dong Hwan Lee, Suwon-si (KR); Dong Jin Lee, Suwon-si (KR); Boum Seock Kim, Suwon-si (KR); Ju Hyoung Park, Suwon-si (KR)

(73) Assignee: SAMSUNG ELECTRO-MECHANICS CO., LTD., Suwon-si (KR)

(21) Appl. No.: 18/753,720

(22) Filed: Jun. 25, 2024

(30) Foreign Application Priority Data
Aug. 7, 2023 (KR) 10-2023-0102793

(51) Int. Cl. H01F 27/29; H01F 27/24; H01F 27/28

(52) U.S. Cl. CPC H01F 27/29; H01F 27/24; H01F 27/2804; H01F 2027/2809

(57) ABSTRACT

A coil component according to an aspect of the present disclosure includes a body including a magnetic material; a coil disposed in the body; an external electrode including a first layer connected to the coil and including at least one of Pd and Cr, a second layer disposed on the first layer and including Ni, and a third layer disposed on the second layer and including a conductive material and resin.

### CROSS-REFERENCE TO RELATED APPLICATION(S)

This application claims benefit of priority to Korean Patent Application No. 10-2023-0102793 filed on Aug. 7, 2023 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, which is a coil component, may be a representative passive electronic component forming an electronic circuit and eliminating noise, and may be used for a resonant circuit and a filter circuit amplifying a signal in a specific frequency band by being combined with a capacitor using electromagnetic properties.

Recently, as the global automobile market share for electric vehicles rapidly increases, demand for high-efficiency inductors for electrical applications may rapidly increase. The most basic requirement for an electronic component may be reliability. In actual use, vehicle components may be inevitably exposed to higher stress and vibrations than general IT products. In other words, the vehicle component may need to satisfy reliability under higher temperatures and a longer periods of time than reliability of general household components. Accordingly, ensuring high reliability of vehicle components has become an important issue, and in particular, reliability of a coupling region connecting a coil to an electrode may be more important than anything else.

### SUMMARY

An aspect of the present disclosure is to improve product reliability of a coil component by reinforcing bondability of an external electrode.

According to an aspect of the present disclosure, a coil component includes a body including a magnetic material; a coil disposed in the body; and an external electrode including: a first layer connected to the coil and including at least one of Pd and Cr, a second layer disposed on the first layer and including Ni, and a third layer disposed on the second layer and including a conductive material and resin.

According to an aspect of the present disclosure, a coil component includes a body including a magnetic material; a coil disposed in the body; an insulating layer disposed on a side surface of the body and including an opening; and an external electrode including: a metal layer disposed on the opening and connected to both ends of the coil, and a conductive resin layer disposed on the metal layer, wherein the metal layer includes Ni.

According to an aspect of the present disclosure, a coil component includes a body including a magnetic material; a coil disposed in the body; and an external electrode including: a metal layer disposed on at least one of a first surface and a second surface opposing each other in a first direction of the body and connected to both ends of the coil, and a conductive resin layer disposed on the metal layer, wherein the metal layer includes Ni, and wherein the metal layer extends to at least one of a fifth surface and a sixth surface opposing each other in a third direction of the body.

According to an aspect of the present disclosure, a coil component includes a body including a magnetic material; a coil disposed in the body; an external electrode including: a metal layer including Ni and connected to the coil, and a conductive resin layer disposed on the metal layer; and an insulating layer disposed on at least a portion of a first portion of a surface of the body, wherein the first portion is not covered by the external electrode, and wherein the metal layer and the conductive resin layer cover at least a portion of the insulating layer.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is a cross-sectional diagram taken along line I-I′ in FIG. 1;

FIG. 3 is a cross-sectional diagram illustrating a coil component according to a second embodiment of the present disclosure, corresponding to FIG. 2;

FIG. 4 is a cross-sectional diagram illustrating a coil component according to a third embodiment of the present disclosure, corresponding to FIG. 2; and

FIG. 5 is a cross-sectional diagram illustrating a comparative example, illustrating an external electrode structure of a general coil component.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An exhibition used in the singular encompasses the exhibition of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the exhibition that an element is disposed “on” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the X-direction may be defined as a first direction or a length direction, the Y-direction may be defined as a second direction or a width direction, and the Z-direction may be defined as a third direction or a thickness direction.

In the drawings, the same elements will be indicated by the same reference numerals. Also, redundant descriptions and detailed descriptions of known functions and elements which may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

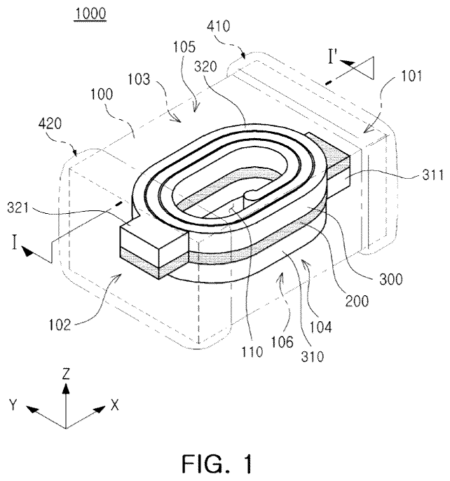

FIG. 1 is a perspective diagram illustrating a coil component according to a first embodiment. FIG. 2 is a cross-sectional diagram taken along line I-I′ in FIG. 1.

Referring to FIGS. 1 and 2, the coil component 1000 according to the first embodiment may include a body 100, a coil 300 and external electrodes 410 and 420, and may further include a support member 200.

The body 100 may form an exterior of the coil component 1000 in the embodiment, and the support member 200 and the coil 300 may be embedded therein.

The body 100 may have a hexahedral shape.

The body 100 may include a first surface 101 and a second surface 102 opposing each other in the first direction (X-direction), a third surface 103 and a fourth surface 104 opposing each other in the second direction (Y-direction), and a fifth surface 105 and a sixth surface 106 opposing each other in the third direction (Z-direction). The third to sixth surfaces 103, 104, 105, and 106 may be side surfaces connecting the first surface 101 to the second surface 102. The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape. For example, the body 100 may include two or more magnetic powders having different average diameters.

The insulating resin may include epoxy, polyimide, a liquid crystal polymer, or the like, alone or in combination but an embodiment thereof is not limited thereto.

The body 100 may include a core 110 penetrating the coil 300, which will be described later. The core 110 may be formed by filling the through-hole of the coil 300 with a magnetic composite sheet, but an embodiment thereof is not limited thereto.

The coil component 1000 according to the first embodiment may further include the support member 200.

The support member 200 may be buried in the body 100. The support member 200 may support the coil 300, which will be described later. The support member 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the support member 200 may be formed of an insulating material such as prepreg, Ajinomoto build-up film (ABF), FR-4, bismaleimide triazine (BT) film, and photo imaginable dielectric (PID) film, but an embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide improved rigidity. When the support member 200 is formed of an insulating material not including glass fibers, an overall thickness of the coil 300 may be easily reduced. When the support member 200 is formed of an insulating material including a photosensitive insulating resin, the number of processes for forming the coil 300 may be reduced, which may be advantageous in reducing production costs, and a fine via may be formed.

The coil 300 may be buried in the body 100, and the coil 300 may be disposed on at least one surface of the support member 200. The coil 300 may exhibit properties of the coil component. For example, when the coil component 1000 in the embodiment is used as a power inductor, the coil 300 may stabilize power supply of an electronic device by storing an electric field as a magnetic field and maintaining an output voltage.

The coil 300 may include coil patterns 310, 320 and a via. Specifically, with respect to the direction in FIG. 1, the first coil pattern 310 and the end 311 of the first coil pattern may be disposed on one surface (a lower surface) of the support member 200, and the second coil pattern 320 and the end 321 of the second coil pattern may be disposed on the other surface (an upper surface) of the support member 200. The via may penetrate the support member 200 and may be in contact with the first coil pattern 310 and the second coil pattern 320, respectively. Accordingly, the coil 300 may function as a single coil forming one or more turns around the core 110.

Each of the first coil pattern 310 and the second coil pattern 320 may have a planar spiral shape forming at least one turn around the core 110. As an example, the first coil pattern 310 may form at least one turn about the core 110 on a lower surface of the support member 200.

At least one of the via and the coil patterns 310 and 320 may include one or more conductive layers. For example, when the second coil pattern 320, the end 321 and the via of the second coil pattern 320 are formed by plating on the other surface side of support member 200, the end 321 and the via of the second coil pattern 320 and the second coil pattern may include a seed layer and an electrolytic plating layer such as an electroless plating layer. Here, the electroplating layer may be a single-layer structure or a multilayer structure. An electroplating layer having a multilayer structure may be formed as a conformal film structure in which one electroplating layer is covered by another electroplating layer, or may be formed in a shape in which another electroplating layer is laminated to only one surface of one electroplating layer. The seed layer of the second coil pattern 320, the seed layer of the end 321 of the second coil pattern, and the seed layer of the via may be formed integrally and no boundary may be formed therebetween, but an embodiment thereof is not limited thereto. The electroplating layer of the second coil pattern 320, the electroplating layer of end 321 of the second coil pattern, and the electroplating layer of the via may be formed integrally, such that a boundary may not be formed therebetween, but an embodiment thereof is not limited thereto.

As another example, with respect to the direction in FIG. 1, when the first coil pattern 310 and an end thereof disposed on a lower surface of the support member 200, and the second coil pattern 320 and an end thereof disposed on an upper surface side of the support member 200 are separately formed, and the coil 300 is formed by collectively laminating the components on the support member 200, the via may include a high-melting-point metal layer and a low-melting-point metal layer having a melting point lower than a melting point of the high-melting-point metal layer. Here, the low-melting-point metal layer may be formed of solder including lead (Pb) and/or tin (Sn). At least a portion of the low-melting-point metal layer may be melted due to pressure and temperature during collective-laminating, and for example, an intermetallic compound layer (IMC Layer) may be formed at a boundary between the low-melting-point metal layer and the second coil pattern 320.

In FIG. 1, the coil patterns 310, 320 and the ends 311, 321 thereof may be formed to protrude from lower and upper surfaces of the support member 200, respectively. As another example, the first coil pattern 310 and the end 311 thereof may be formed to protrude from the lower surface of the support member 200, and the second coil pattern 320 and the end 321 thereof may be embedded in the upper surface of the support member 200 and the upper surface of each of the second coil pattern 320 and the end 321 thereof may be exposed to the upper surface of the support member 200. In this case, a recess portion may be formed on the upper surface of the end 321 of the second coil pattern 320 and/or the second coil pattern 320, and the upper surface of the second coil pattern 320 and/or the end 321 of the second coil pattern and the upper surface of the support member 200 may not be coplanar with each other. As another example, the second coil pattern 320 and the end 321 thereof may be formed to protrude from the upper surface of the support member 200, and the first coil pattern 310 and the end 311 thereof may be embedded in the lower surface of the support member 200, such that each lower surface of the first coil pattern 310 and the end 311 thereof may be exposed to the lower surface of the support member 200. In this case, a recess portion may be formed on the lower surface of the end 311 of the first coil pattern 310 and/or the first coil pattern, and the lower surface of the end 311 of the first coil pattern 310 and/or the first coil pattern and the lower surface of the support member 200 may not be coplanar with each other.

The via and the coil patterns 310 and 320 may be formed of a conductive material such as copper (Cu), aluminum (Al), silver (Ag), tin (Sn), gold (Au), nickel (Ni), lead (Pb), titanium (Ti), or alloys thereof, but an embodiment thereof is not limited thereto.

The coil component according to the first embodiment may include external electrodes 410 and 420 connected to the coil 300. The external electrodes 410 and 420 may be disposed on the surface of the body 100 and may be connected to both ends of the coil 300. In the embodiment, the both ends 311 and 321 of the coil 300 may extend to the first surface 101 and the second surface 102 of the body 100, respectively. Accordingly, the first external electrode 410 may be disposed on the first surface 101 of the body and may be in contact with and connected to the end 311 of the first coil pattern extending to the first surface 101 of the body 100. The second external electrode 420 may be disposed on the second surface 102 and may be in contact with and connected to the end 321 of the second coil pattern extended to the second surface 102 of the body.

The external electrodes 410 and 420 may be formed as a multilayer structure. Specifically, the external electrodes 410 and 420 may be connected to coil 300, and may include first layers 411 and 421 containing at least one of palladium (Pd) and chromium (Cr), second layers 412 and 422 disposed on the first layer and third layer 413 and 423 disposed on the second layer and containing conductive material and resin.

Since the description of the first external electrode 410 may also be applied to the second external electrode 420, the description of the second external electrode may be replaced with the description of the first external electrode below.

Referring to FIG. 2, the first external electrode 410 may include a first layer 411 connected to the end 311 of the first coil pattern. The first layer 411 may include at least one of palladium (Pd) and chromium (Cr).

The first layer 411 may cover the body 100 and the first surface 101. As described above, the end 311 of the first coil pattern extends to the first surface 101 of the body, such that the first layer 411 may be disposed on the first surface 101 of the body 100 and may be connected to the end 311 of the first coil pattern.

The first layer 411 may be connected to the end 311 of the first coil pattern, and may improve contact force between the coil pattern 310 and the second layer 412, which will be described later. Specifically, the first layer 411 may expand the end 311 of the first coil pattern, thereby expanding the contact area with the second layer 412. In other words, when the contact area in which the end of the coil pattern is in contact with the external electrode is narrow, the area may cause defects in contact between the coil and the external electrode and may increase contact resistance. To address this issue, the contact area between the end of the coil pattern and the external electrode may increase.

Also, since the first layer 411 is formed of a different material from the material forming the coil 300, the first layer 411 may prevent tin (Sn) from diffusing together with the second layer 412, which will be described later.

The second layer 412 may be disposed on the first layer 411 and may include nickel (Ni). The second layer 412 may prevent diffusion of tin (Sn) present in a layer outer than the second layer into the coil component. Specifically, tin (Sn) in the solder applied when mounting the coil component on the board, or tin (Sn) in the external electrode fourth layer 414, which will be described later, may be prevented from diffusing toward the coil.

FIG. 5 is a cross-sectional diagram illustrating a comparative example, illustrating an external electrode structure of a general coil component. In the general coil component according to FIG. 5, an external electrode may include multilayer structures 43, 44, and 45. Specifically, the multilayer structures 43, 44, and 45 may include a third layer 413, a fourth layer 414, and a fifth layer 415 in an embodiment described later. That is, differently from an embodiment, the first layer and second layer may not be included.

When the coil component in the comparative example is exposed to a high temperature (approximately 150° C. or higher) or a harsh environment of high temperature and high humidity, diffusion of tin (Sn) included in the coil component or an external material (e.g., solder) may become active. When the diffusion of tin (Sn) accelerates, tin (Sn) may permeate into the internal coil, which may ultimately facilitate deterioration of the coil component. Specifically, tin (Sn) may permeate into the component and may react with copper (Cu), causing growth of an intermetallic compound (IMC), and accordingly, interfacial bonding force of the coil component may be reduced such that reliability of the coil component may decrease.

The first layer 411 and the second layer 412 according to an embodiment may perform a function of preventing tin (Sn) from spreading to the internal coil. The first layer 411 and the second layer 412 may be a material which may stably react with tin (Sn) and may form an intermetallic compound (IMC). Specifically, the second layer 412 may include nickel (Ni), and a less reactive noble metal. As an example, a reaction rate of the Ni/Sn-based intermetallic compound (IMC) may be significantly lower than a reaction rate of Cu—Sn, and may prevent diffusion.

The third layer 413 may be disposed on the second layer 412 and may include conductive material and resin. Specifically, the third layer 413 may include resin and metal particles dispersed in the resin. The metal particle may be one or more selected from a group consisting of copper (Cu), nickel (Ni), silver (Ag), cobalt (Co), palladium (Pd), and platinum (Pt) particles, and may be an alloy particle including the above elements. The resin may be epoxy, polyimide, or the like. The third layer 413 may include resin and metal particles dispersed in the resin, and may be an Ag-epoxy resin layer. In this case, one or more of tin (Sn) component, nickel (Ni) component in the second layer 412, silver (Ag) component in the third layer 413 and copper (Cu) component in the coil 300, diffused from the outside, may form an intermetallic compound (IMC), such that tin (Sn) may be prevented from permeating into a boundary surface of the internal coil and deteriorating the coil component. The third layer 413 may extend to the third insulating layer 630 and may be disposed on the body fifth surface 105 and the sixth surface 106, which will be described later.

The external electrode 410 may further include a fourth layer 414 disposed on the third layer 413 and a fifth layer 415 disposed on the fourth layer 414. The fourth layer 414, together with the third layer 413, may perform a function of improving conductivity of the first external electrode. The fifth layer 415 may perform a function of improving bondability with soldering when the coil component is mounted on a substrate. The fourth layer may include nickel (Ni), and the fifth layer may include tin (Sn), but an embodiment thereof is not limited thereto.

As the external electrodes 410 and 420 include a multilayer structure of the first layer to the fifth layer 411, 412, 413, 414, and 415 as described above, reliability deterioration due to tin (Sn) diffusion in a high temperature load environment may be effectively prevented.

When the thickness of the second layer 412 is T₁ and the thickness of the fourth layer 414 is T₂, 0.5 T₂≤T₁ may be satisfied. Specifically, in the case of a vehicle coil component, higher reliability may be required than that of general household coil components, and as an example, operation reliability may be required for approximately twice the usage time of general household coil components. Accordingly, as compared to a general household coil component, the coil component according to an embodiment may include the second layer 412, which may prevent diffusion of tin (Sn) present in the layer outer than (disposed external to) the second layer into the coil component. Also, considering the amount of tin (Sn) present externally in the fifth layer 415 and the component being destroyed (consumed) by reacting with nickel (Ni) of the fourth layer 414, when the thickness of the second layer 412 is formed to be half the thickness of the fourth layer 414, the thickness may be sufficient to prevent diffusion of tin (Sn) remaining after reaction with nickel (Ni) of the fourth layer 414.

The thickness of the second layer 412 and the fourth layer 414 may be measured by the method described below. First, a sample having an exposed cross-section may be prepared by grinding the coil component to about ½ the depth in the second direction (Y-direction). Thereafter, when observing the collected cross-section sample using an optical microscope, the cross-section structure of the second layer 412 and the fourth layer 414 may be confirmed as illustrated in FIG. 2, and by measuring the length of the second layer 412 and the fourth layer 414 in the first direction (X-direction), the thickness of the second layer 412 and the fourth layer 414 may be measured. Other methods and/or tools appreciated by one of ordinary skill in the art, even if not described in the present disclosure, may also be used.

The coil component according to the first embodiment may further include an insulating film IF. The insulating film IF may be formed on the support member 200 and coil 300. The insulating film IF may be provided to insulate the coil 300 from the body 100, and may include a generally used insulating material, such as parylene. An insulating material included in the insulating film IF is not limited to any particular material. The insulating film IF may be formed by a method such as vapor deposition, but an embodiment thereof is not limited thereto, and the insulating film IF may be formed by laminating the insulating film on both surfaces of the support member 200. In the former case, the insulating film IF may be formed in the form of a conformal film along surfaces of the support member 200 and the coil 300. Meanwhile, in an embodiment, the insulating film IF may be an optional component, such that, when the body 100 may ensure sufficient insulating resistance at an operating voltage and operating current of the coil component 1000 according to the embodiment, the insulating film IF may not be provided.

The coil component according to the first embodiment may further include a third insulating layer 630 disposed on the fifth surface 105 and the sixth surface 106 opposing each other in the third direction of the body (Z-direction). The third insulating layer 630 may be disposed on the fifth surface 105 and the sixth surface 106 of the body, and may be disposed between the first and second external electrodes 410 and 420 such that the coil component may be electrically protected, leakage current may be reduced and plating spread may be prevented when external electrode is formed.

The third layer 413 may extend to the fifth surface 105 and the sixth surface 106 of the body and may also be disposed on the third insulating layer 630. In other words, the third insulating layer 630 may be in direct contact with the third layer 413, and in this case, the third insulating layer 630 and the third layer 413 may further ensure bonding strength through epoxy bonding.

The third insulating layer 630 may include thermoplastic resin such as polystyrene resin, vinyl acetate resin, polyester resin, polyethylene resin, polypropylene resin, polyamide resin, rubber resin, acrylic resin, a thermosetting resin such as phenol resin, epoxy resin, urethane resin, melamine resin, and alkyd resin, photosensitive resin, parylene, SiOₓ, or SiNₓ.

### Second Embodiment

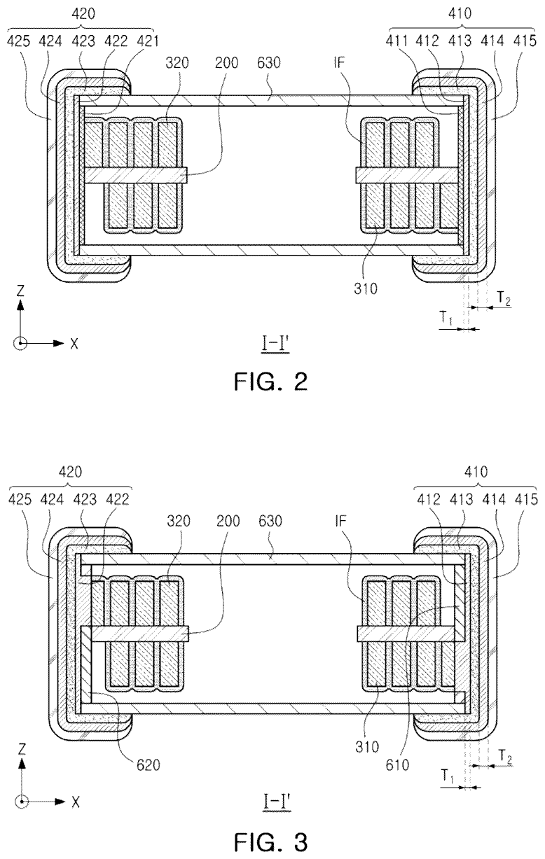

FIG. 3 is a cross-sectional diagram illustrating a coil component according to a second embodiment of the present disclosure, corresponding to FIG. 2.

As compared to the first embodiment, the coil component according to the second embodiment may not include the first layers 411 and 421 of the external electrode. Also, insulating layers 610, 620 disposed on a side surface of the body and including an opening may be further included.

The first and second insulating layers 610 and 620 may be disposed on the side surface of the body 100, respectively. Specifically, the first and second insulating layers 610 and 620 may be disposed on the first surface 101 and the second surface 102, respectively, opposing each other in the first direction of the body (X-direction).

The first and second insulating layers 610 and 620 may include an opening O. The opening O of the first and second insulating layers 610 and 620 may expose both ends of the coil 300. Referring to FIG. 3, the first and second insulating layers 610 and 620 may be disposed on the first surface 101 and the second surface 102, and both ends 311 and 321 of the coil may be exposed through the opening O.

The first and second insulating layers 610 and 620 may include thermoplastic resin such as polystyrene resin, vinyl acetate resin, polyester resin, polyethylene resin, polypropylene resin, polyamide resin, rubber resin, acrylic resin, a thermosetting resin such as phenol resin, epoxy resin, urethane resin, melamine resin, and alkyd resin, photosensitive resin, parylene, SiOₓ, or SiNₓ.

The first and second insulating layers 610 and 620 may be formed by applying a liquid insulating resin to the surface of the body 100, applying an insulating paste to the surface of the body 100, laminating an insulating film on the surface of the body 100, or forming insulating resin on the surface of body 100 by vapor deposition. As the insulating film, a dry film (DF) including a photosensitive insulating resin, Ajinomoto build-up film (ABF) or polyimide film excluding a photosensitive insulating resin may be used.

The metal layers 412 and 422 may be disposed in the opening O. The metal layers 412 and 422 may be disposed in the opening and may be connected to both ends 311 and 321 of the coil. That is, the metal layers 412 and 422 may be connected to both ends 311 and 321 of the coil through the opening.

The metal layers 412 and 422 may cover the first and second insulating layers 610 and 620. Specifically, referring to FIG. 3, a portion of the metal layers 412 and 422 may fill the opening O of the first and second insulating layers 610 and 620, and the other may be disposed on the first and second insulating layers 610 and 620 and may cover the components.

In the coil component according to the second embodiment, to prevent tin (Sn) in the solder or tin (Sn) in the fourth layer 414 of the external electrode from diffusing into the coil component, instead of the first layer 411, the first and second insulating layers 610 and 620 may be disposed on a side surface of the body. Specifically, the first and second insulating layers 610 and 620 may cover the side surface of the body 100 other than the both ends 311 and 321 of the coil, thereby effectively blocking a path through which tin (Sn) diffuses from the outside. Also, by connecting the both ends 311 and 321 of the coil to the second layers 412 and 422 of the external electrode through the opening O, connection reliability of the external electrode may be ensured.

Here, the metal layers 412 and 422 may be the same components as the second layers 412 and 422 described in the first embodiment. The description of the second layer has been described in detail in the first embodiment, and a detailed description thereof will not be provided.

Conductive resin layers 413 and 423 may be disposed on the metal layers 412 and 422. Here, the conductive resin layers 413 and 423 may be the same components as the third layers 413 and 423 described in the first embodiment. The description of the third layer has been described in detail in the first embodiment, and a detailed description thereof will not be provided.

As the descriptions of the other components of the second embodiment overlap with those of the first embodiment, the detailed description thereof will not be provided.

### Third Embodiment

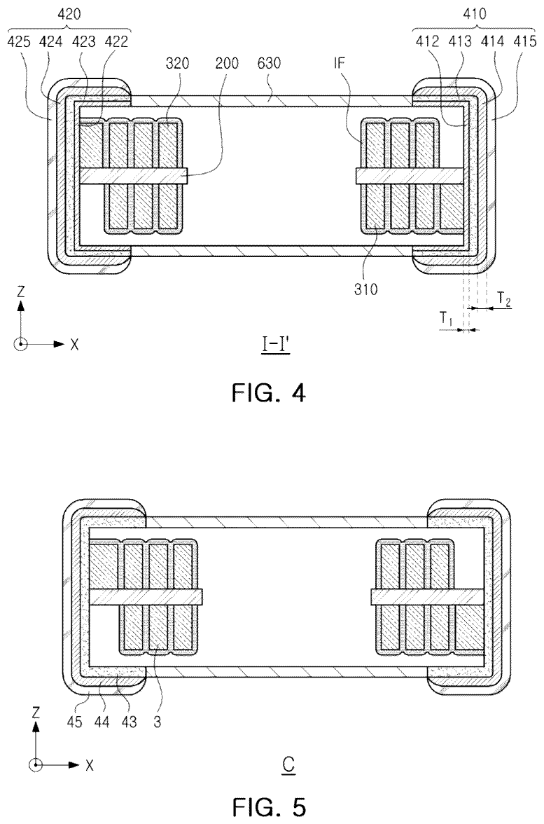

FIG. 4 is a cross-sectional diagram illustrating a coil component according to a third embodiment of the present disclosure, corresponding to FIG. 2.

As compared to the first embodiment, the coil component according to the third embodiment may not include the first layers 411 and 421 of the external electrode. Also, the metal layers 412 and 422 disposed on a side surface of the body may extend to at least one of the fifth surface and the sixth surface opposing each other in the third direction of the body.

The metal layers 412 and 422 may be disposed on the first surface 101 and the second surface 102 of the body, and may also extend to at least one of the fifth surface 105 and the sixth surface 106 of the body.

Generally, an external electrode may be formed on a side surface of the body, and also on the upper surface/lower surface. Also, when mounting components, solder (Sn) may be disposed on a side surface of the body, and also in proximity to the mounting surface. Accordingly, tin (Sn) to diffuse into the coil component due to a tin (Sn) component on the body upper surface/lower side and deterioration of the coil component may be facilitated.

Accordingly, as compared to the above-described embodiment, the coil component according to the third embodiment may efficiently block permeation of tin (Sn) by disposing the metal layers 412 and 422 to extend to the upper surface and the lower surface of the body.

Here, the metal layers 412 and 422 may be the same components as the second layers 412 and 422 described in the first embodiment. The description of the second layer has been described in detail in the first embodiment, and a detailed description thereof will not be provided.

Conductive resin layers 413 and 423 may be disposed on the metal layers 412 and 422. The conductive resin layers 413 and 423 may be disposed to extend to at least one of the fifth surface 105 and the sixth surface 106 of the body 100 along the metal layers 412 and 422.

Here, the conductive resin layers 413 and 423 may be the same components as the third layers 413 and 423 described in the first embodiment. The description of the third layer has been described in detail in the first embodiment, and a detailed description thereof will not be provided.

As the descriptions of the other components of the third embodiment overlap with those of the first embodiment, detailed descriptions thereof will not be provided.

According to the aforementioned embodiments, the issue of the Sn component of the external electrode deteriorating bondability between the external electrode and the internal coil may be addressed.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a magnetic material;
a coil disposed in the body; and
an external electrode including:
a first layer connected to the coil and including at least one of Pd and Cr,
a second layer disposed on the first layer and including Ni, and
a third layer disposed on the second layer and including a conductive material and resin.

2. The coil component of claim 1, wherein the third layer includes one or more selected from the group consisting of Ag, Ni, Cu, Co, Pd, and Pt.

3. The coil component of claim 1, wherein the external electrode further includes a fourth layer disposed on the third layer, and wherein the fourth layer includes Ni.

4. The coil component of claim 3, wherein, when a thickness of the second layer is defined as T₁ and a thickness of the fourth layer is defined as T₂, 0.5 T₂≤T₁ is satisfied.

5. The coil component of claim 3,
wherein the external electrode further includes a fifth layer disposed on the fourth layer, and
wherein the fifth layer includes Sn.

6. The coil component of claim 1, wherein the first layer covers a first surface and a second surface opposing each other in a first direction of the body.

7. The coil component of claim 1, further comprising:
an insulating layer disposed on a fifth surface and a sixth surface opposing each other in a third direction of the body.

8. The coil component of claim 7, wherein the third layer extends to the fifth surface and the sixth surface of the body and is disposed on the insulating layer.

9. The coil component of claim 1, further comprising:
a support member disposed in the body,
wherein the coil is disposed on at least one surface of the support member.

10. A coil component, comprising:
a body including a magnetic material;
a coil disposed in the body;
an insulating layer disposed on a side surface of the body and including an opening; and
an external electrode including:
a metal layer disposed in the opening and connected to both ends of the coil, and
a conductive resin layer disposed on the metal layer,
wherein the metal layer includes Ni.

11. The coil component of claim 10, wherein the insulating layer does not cover both ends of the coil.

12. The coil component of claim 10, wherein the metal layer is connected to the both ends of the coil through the opening.

13. The coil component of claim 10, wherein the metal layer covers the insulating layer.

14. The coil component of claim 10, wherein the external electrode further includes a Ni layer disposed on the conductive resin layer and a Sn layer disposed on the Ni layer.

15. A coil component, comprising:
a body including a magnetic material;
a coil disposed in the body; and
an external electrode including:
a metal layer disposed on at least one of a first surface and a second surface opposing each other in a first direction of the body and connected to both ends of the coil, and
a conductive resin layer disposed on the metal layer,
wherein the metal layer includes Ni, and
wherein the metal layer extends to at least one of a fifth surface and a sixth surface opposing each other in a third direction of the body.

16. The coil component of claim 15, wherein the conductive resin layer extends to at least one of the fifth surface and the sixth surface and along the metal layer.

17. A coil component, comprising:
a body including a magnetic material;
a coil disposed in the body;
an external electrode including:
a metal layer including Ni and connected to the coil, and
a conductive resin layer disposed on the metal layer; and
an insulating layer disposed on at least a portion of a first portion of a surface of the body, wherein the first portion is not covered by the external electrode, and
wherein the metal layer and the conductive resin layer cover at least a portion of the insulating layer.

18. The coil component of claim 17, wherein the conductive resin layer includes Ag.

19. The coil component of claim 18, wherein the insulating layer does not cover both ends of the coil.

20. The coil component of claim 19, further comprising a layer that is disposed between the coil and the metal layer and that includes at least one of Pd and Cr.

21. The coil component of claim 19, wherein the insulating layer is disposed on a side surface of the body and includes an opening, and
wherein the metal layer is disposed in the opening and connected to both ends of the coil.

22. The coil component of claim 19, wherein the metal layer extends to the surface of the body on which the insulating layer is disposed.
